(19) United States
(12) Patent Application Publication
(10) Pub. No.: US 2026/0077720 A1
(43) Pub. Date: Mar. 19, 2026

(54) VEHICLE CARGO BED SYSTEMS INCLUDING A STAIR ASSEMBLY, A LOAD STOP, OR BOTH

(71) Applicant: Ford Global Technologies, LLC, Dearborn, MI (US)

(72) Inventors: William Charles Brick, Royal Oak, MI (US); Michael M. Azzouz, Farmington, MI (US); Scott Nydam, Farmington Hills, MI (US); Jay John Meyer, Howell, MI (US); Amol Borkar, Dearborn, MI (US)

(21) Appl. No.: 19/400,296

(22) Filed: Nov. 25, 2025

Related U.S. Application Data
(63) Continuation of application No. 18/188,610, filed on Mar. 23, 2023, now Pat. No. 12,508,995.
(60) Provisional application No. 63/345,495, filed on May 25, 2022.
(60) Provisional application No. 63/395,000, filed on Aug. 4, 2022.
(60) Provisional application No. 63/411,797, filed on Sep. 30, 2022.

(51) Int. Cl. B60R 3/02; B62D 33/027

(52) U.S. Cl. CPC B60R 3/02; B62D 33/0273

(57) ABSTRACT

A stair assembly for a vehicle includes a first support arm assembly and a second support arm assembly spaced apart from one another, a first step extending between the first support arm assembly and the second support arm assembly, and a second step extending between the first support arm assembly and the second support arm assembly. The first support arm assembly includes a fixed rail and a telescoping portion movable relative to the fixed rail. The first step and the second step are coupled to the telescoping portion such that extension of the telescoping portion moves the first step and the second step from a retracted position toward an extended position. The first step and the second step are pivotable relative to the first support arm assembly and the second support arm assembly to a staircase position in which step surfaces of the first step and the second step face upward.

### CROSS-REFERENCE TO RELATED APPLICATIONS

This application is a continuation of U.S. patent application Ser. No. 18/188,610, filed Mar. 23, 2023, which is incorporated herein by reference in its entirety. This application also claims the benefit of U.S. Provisional Application Nos. 63/345,495 filed on May 25, 2022; 63/395,000 filed on Aug. 4, 2022; and 63/411,797 filed on Sep. 30, 2022, each of which is incorporated herein by reference in its entirety.

### TECHNICAL FIELD

This disclosure relates generally to a cargo bed of a vehicle, and more particularly, to a stair assembly that can be used to access the cargo bed.

### BACKGROUND

Some vehicles, pickup trucks, include a cargo bed. Users can utilize cargo beds to carry various types of cargo. The cargo bed can be located behind a passenger compartment of a vehicle. A tailgate can enclose an aft end of the cargo bed. Some cargo beds can transition back-and-forth between a standard bed position and an extended bed position.

### SUMMARY

In some aspects, the techniques described herein relate to a stair assembly for a vehicle, including: a first support arm assembly and a second support arm assembly spaced apart from one another; a first step extending between the first support arm assembly and the second support arm assembly; a second step extending between the first support arm assembly and the second support arm assembly; and the first support arm assembly including a fixed rail and a telescoping portion movable relative to the fixed rail, wherein the first step and the second step are coupled to the telescoping portion such that extension of the telescoping portion moves the first step and the second step from a retracted position toward an extended position, wherein the first step and the second step are pivotable relative to the first support arm assembly and the second support arm assembly to a staircase position in which step surfaces of the first step and the second step face upward.

In some aspects, the techniques described herein relate to a stair assembly, wherein the telescoping portion includes an inner bar received within an outer bar.

In some aspects, the techniques described herein relate to a stair assembly, further including a shield covering at least part of the telescoping portion when the telescoping portion is extended.

In some aspects, the techniques described herein relate to a stair assembly, wherein the first support arm assembly and the second support arm assembly each include a four-bar linkage that constrains pivoting of the first step and the second step to maintain the step surfaces substantially horizontal during transition to the staircase position.

In some aspects, the techniques described herein relate to a stair assembly, further including a locking assembly configured to retain the first step and the second step in the retracted position.

In some aspects, the techniques described herein relate to a stair assembly, wherein the first step and the second step pivot together to the staircase position.

In some aspects, the techniques described herein relate to a stair assembly, wherein the first support arm assembly and the second support arm assembly each include two outer bars and two inner bars forming a parallelogram linkage.

In some aspects, the techniques described herein relate to a stair assembly, wherein the outer bars of the first support arm assembly define a first four-bar linkage and the outer bars of the second support arm assembly define a second four-bar linkage, the first and second four-bar linkages being parallel to one another.

In some aspects, the techniques described herein relate to a stair assembly, wherein the fixed rail couples the first support arm assembly to a tailgate of the vehicle.

In some aspects, the techniques described herein relate to a tailgate system for a vehicle, including: a tailgate movable between a closed position and an open position; a stair assembly movable between a stowed position within the tailgate and a staircase position outside the tailgate, the stair assembly including: a first support arm assembly having a fixed rail and an a telescoping portion that is telescopically received within the fixed rail; a second support arm assembly spaced from the first support arm assembly; a first step and a second step each spanning between the first support arm assembly and the second support arm assembly; and a pivot connection between each of the first step and the second step and the first support arm assembly and the second support arm assembly, wherein movement of the extendable rail from the stowed position to an extended position moves the first step and the second step outward of the tailgate, and wherein pivoting of the first step and the second step relative to the first support arm assembly and the second support arm assembly positions the first step and the second step in the staircase position.

In some aspects, the techniques described herein relate to a tailgate system, wherein the staircase position is a vertically downward and rearward position relative to the tailgate.

In some aspects, the techniques described herein relate to a tailgate system, wherein the stair assembly is slidable along the fixed rail during movement between the stowed position and the extended position.

In some aspects, the techniques described herein relate to a tailgate system, wherein a locking assembly mounted to the tailgate engages the stair assembly in the stowed position.

In some aspects, the techniques described herein relate to a tailgate system, wherein the first step and the second step pivot together relative to the first support arm assembly and the second support arm assembly such that respective step surfaces remain substantially horizontal in the staircase position.

In some aspects, the techniques described herein relate to a method of deploying a stair assembly of a vehicle, including: opening a tailgate of the vehicle; moving the stair assembly from a stowed position within the tailgate to an extended position outside the tailgate by telescopically extending a support arm assembly of the stair assembly; and pivoting a first step and a second step of the stair assembly downward relative to the support arm assembly to a staircase position in which step surfaces of the first step and the second step face upward to assist a user in entering or exiting a cargo bed of the vehicle.

In some aspects, the techniques described herein relate to a method, further including locking the stair assembly in the stowed position within the tailgate.

In some aspects, the techniques described herein relate to a method, wherein pivoting the first step and the second step includes rotating the first step and the second step together such that the step surfaces remain substantially horizontal throughout rotation.

In some aspects, the techniques described herein relate to a method, further including sliding the stair assembly along a rail in the tailgate during movement from the stowed position to the extended position.

In some aspects, the techniques described herein relate to a method, further including telescoping an inner bar within an outer bar of the support arm assembly during movement to the extended position.

### BRIEF DESCRIPTION OF THE FIGURES

FIG. 1 illustrates a stair assembly to a cargo bed of a vehicle with the stair assembly in a staircase position.

FIG. 2 illustrates a perspective view of the stair assembly of FIG. 1 in a stowed position within a tailgate of the vehicle.

FIG. 3 illustrates the stair assembly of FIG. 1 in an extended position.

FIG. 4 illustrates the stair assembly of FIG. 1 between the extended position of FIG. 3 and the staircase position of FIG. 1.

FIG. 5 illustrates a section view taken at line 5-5 in FIG. 3.

FIG. 6 illustrates a closeup view of an area of FIG. 4.

FIG. 7 illustrates a bottom, perspective view of the stair assembly in the extended position of FIG. 2.

FIG. 7A illustrates a bottom, perspective view of a portion of the stair assembly in a partially extended position.

FIGS. 8A to 8C illustrate perspective views of a stair assembly according to another exemplary embodiment of the present disclosure.

FIGS. 9A and 9B illustrate perspective views of a stair assembly according to yet another exemplary embodiment of the present disclosure.

FIGS. 10A to 10D illustrate selected portions of a vehicle showing a flip-up work surface.

FIGS. 11A to 11C illustrate selected portions of a vehicle having stowable barriers that can be used as a load stop.

FIGS. 12A to 12D illustrate selected portions of a vehicle having a pivotable barriers that can be used as a load stop.

FIGS. 13A to 13D illustrate a roller load stop and selected portions of a vehicle having the roller load stop.

FIGS. 14A and 14B illustrate selected portions of a vehicle having a slide out step and load stop.

### DETAILED DESCRIPTION

A vehicle, such as pickup truck, can include a cargo bed. Some cargo beds are extendable. This disclosure is directed toward systems that can be used in connection with the cargo bed. Some of the disclosed systems are cargo bed access systems that include step assemblies used to assist a user entering and exiting the cargo bed. Some of the disclosed systems instead or additionally include load stops that can help to hold cargo in the cargo bed.

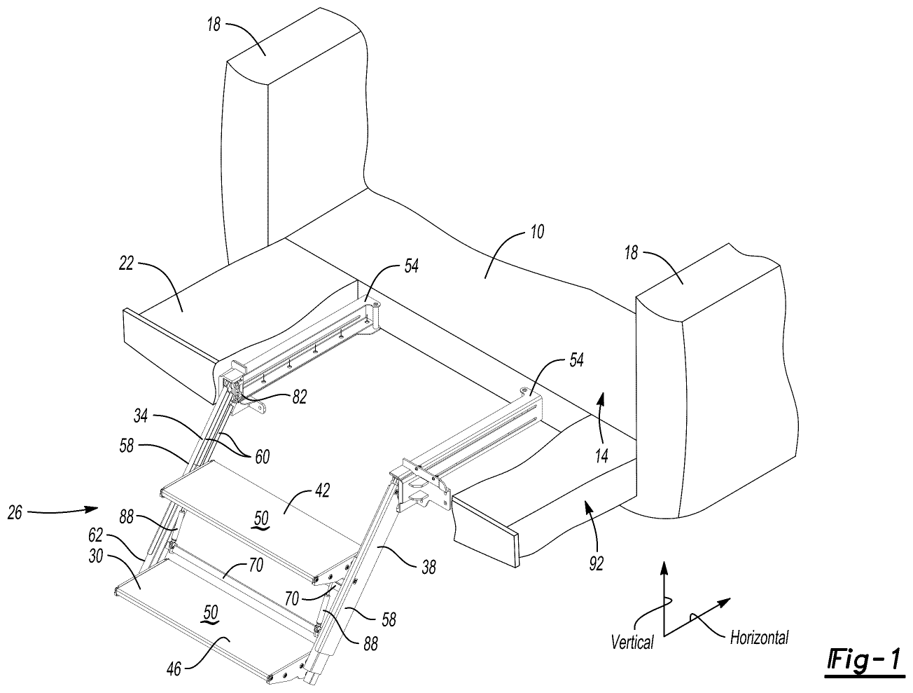

With reference to FIGS. 1-4, in an exemplary embodiment of the present disclosure, a vehicle 10, here a pickup truck, includes a cargo bed 14 between opposing side walls 18. A tailgate 22 of the vehicle 10 can pivot back-and-forth from a closed position (not shown) to an open position. When the tailgate 22 is in the closed position, the tailgate 22 encloses an aft end of the cargo bed 14.

The vehicle 10 includes a cargo bed access system 26, which, in this example, includes a stair assembly 30. The stair assembly 30 is coupled to a vehicle structure—here the tailgate 22.

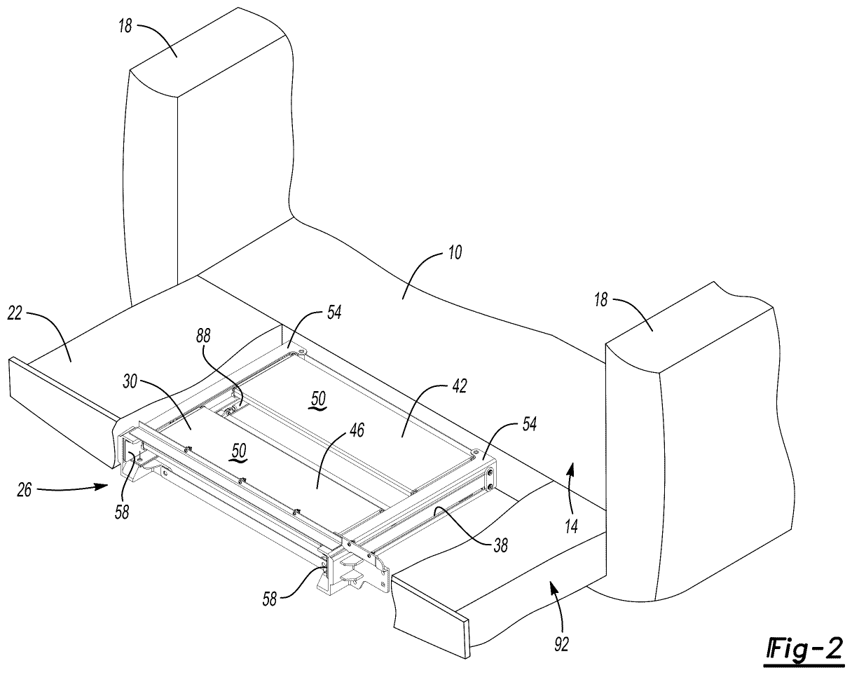

The stair assembly 30 is movable back-and-forth between a stowed position and a staircase position relative to the vehicle structure. When the stair assembly 30 is in the staircase position of FIG. 1, a user can use the stair assembly 30 to enter or exit the cargo bed 14. The stair assembly 30, when in the stowed position, is stowed within the tailgate 22 as shown in FIG. 2.

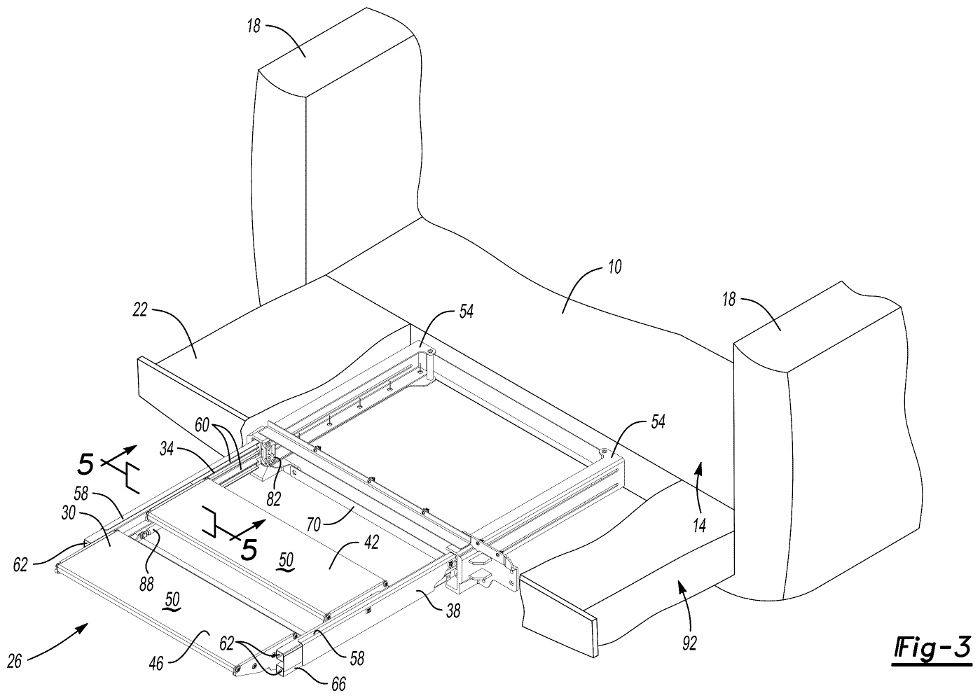

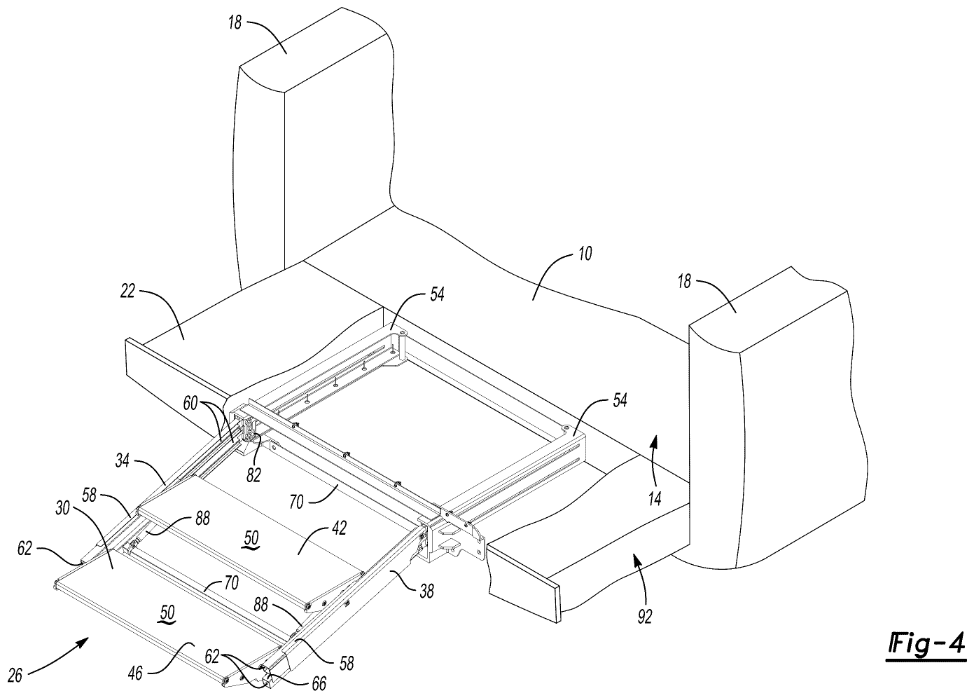

When access to the cargo bed 14 is not required, the tailgate 22 can be in the closed position and the stair assembly 30 in the stowed position. When accessing the cargo bed 14 is desired, the tailgate 22 is pivoted to the open position of FIG. 2. With the tailgate 22 in the open position, the stair assembly 30 is transitioned from the stowed position to an extended position shown in FIG. 3. After reaching the extended position, the stair assembly 30 can be pivoted vertically downward as shown in FIG. 4 until reaching the staircase position of FIG. 1. Vertical and horizontal, for purposes of this disclosure, are with reference to ground and a general orientation of the vehicle 10 during ordinary operation.

When access is no longer required, the stair assembly 30 is pivoted upward from the staircase position to the extended position of FIG. 3 and then slid back within the tailgate 22 until reaching the stowed position of FIG. 2. The tailgate 22 can then be pivoted from the open position to the closed position to enclose the aft end of the cargo bed 14.

With reference now to FIGS. 5-7 and continued reference to FIGS. 1-4, the stair assembly 30 includes a first support arm assembly 34, a second support arm assembly 38, a first step 42, and a second step 46. The first support arm assembly 34 and the second support arm assembly 38 are spaced apart and oriented parallel to each other. The first step 42 and the second step 46 each span from the first support arm assembly 34 to the second support arm assembly 38.

The first step 42 and the second step 46 each include a step surface 50. As the stair assembly 30 transitions from the extended position of FIG. 3 to the staircase position of FIG. 1, the first step 42 and the second step 46 pivot together relative to the support arm assemblies 34 and 38. In this example, pivoting the first step 42 and the second step 46 together maintains the respective step surfaces 50 facing vertically upward.

The first support arm assembly 34 and the second support arm assembly 38, in this example, each include a fixed rail 54, a movable shield 58, two inner bars 60, and two outer bars 62. The inner bars 60 are telescopically received within respective outer bars 62. The two outer bars 62 of the first support arm assembly 34 and the two outer bars 62 of the second support arm assembly 38 provide a four-bar linkage 66. The outer bars 62 can extend and retract relative to the inner bars 60 of the first support arm assembly 34 and the second support arm assembly 38. Braces 70 span between the two outer bars 62 of the first support arm assembly 34 and the two outer bars 62 of the second support arm assembly 38.

The outer bars 62 of the first support arm assembly 34 are received within the movable shield 58 when the stair assembly 30 is in the stowed position of FIG. 2. The movable shield 58, inner bars 60, and outer bars 62 are slidably received within the fixed rail 54 when the stair assembly 30 is in the stowed position of FIG. 2.

The outer bars 62 of the first support arm assembly 34 telescopically extend relative to the inner bars 60 and the movable shield 58 of the first support arm assembly 34 as the stair assembly 30 transitions from the stowed position to the extended position of FIG. 3. The outer bars 62, the inner bars 60, and the movable shield 58 of the first support arm assembly 34 telescopically extend relative to the fixed rail 54 of the first support arm assembly 34 when the stair assembly 30 transitions from the stowed position to the extended position of FIG. 3.

The second support arm assembly 38 telescopically extends similarly to the first support arm assembly 34 with the outer bars 62 of the second support arm assembly 34 telescopically extending from the movable shield 58 and the inner bars 60.

The first step 42 is an upper step in this example. One side of the first step 42 is pivotably coupled to the two outer bars 62 of the first support arm assembly 34 at upper step pivot points 74. The other side of the first step 42 is pivotably coupled to the two outer bars 62 of the second support arm assembly 38 at other upper step pivot points 74.

The second step 46 is a lower step in this example. One side of the second step 46 is pivotably coupled to the two outer bars 62 of the first support arm assembly 34 at lower step pivot points 78. The other side of the second step 46 is pivotably coupled to the two outer bars 62 of the second support arm assembly 38 at other lower step pivot points 78.

Coupling the first step 42 and the second step 46 together using the four-bar linkage 66 causes the first step 42 and the second step 46 to pivot together relative to the first support are assembly 34 and the second support arm assembly 38 when the stair assembly 30 transitions from the extended position of FIG. 3 to the staircase position of FIG. 1.

The inner bars 60 of the first support arm assembly 34 and the inner bars 60 of the second support arm assembly 38 are each pivotably coupled to a respective slider bracket 82. The slider brackets 82 slide with the inner bars 60 within the fixed rails 54 when the stair assembly 30 transitions from the stowed position to the extended position. The slider brackets 82 are not withdrawn from the fixed rails 54 and remain within the fixed rails 54 as the stair assembly 30 is transitioned from the extended position to the staircase position. The slider brackets 82 can prevent the outer bars 62, inner bars 60, and the movable shields 58 from disengaging from the respective fixed rails 54. The movable shield 58 can block a user's fingers from moving in between the outer bars 62 or in between the inner bars 60 as the stair assembly 30 is lowered to the staircase position.

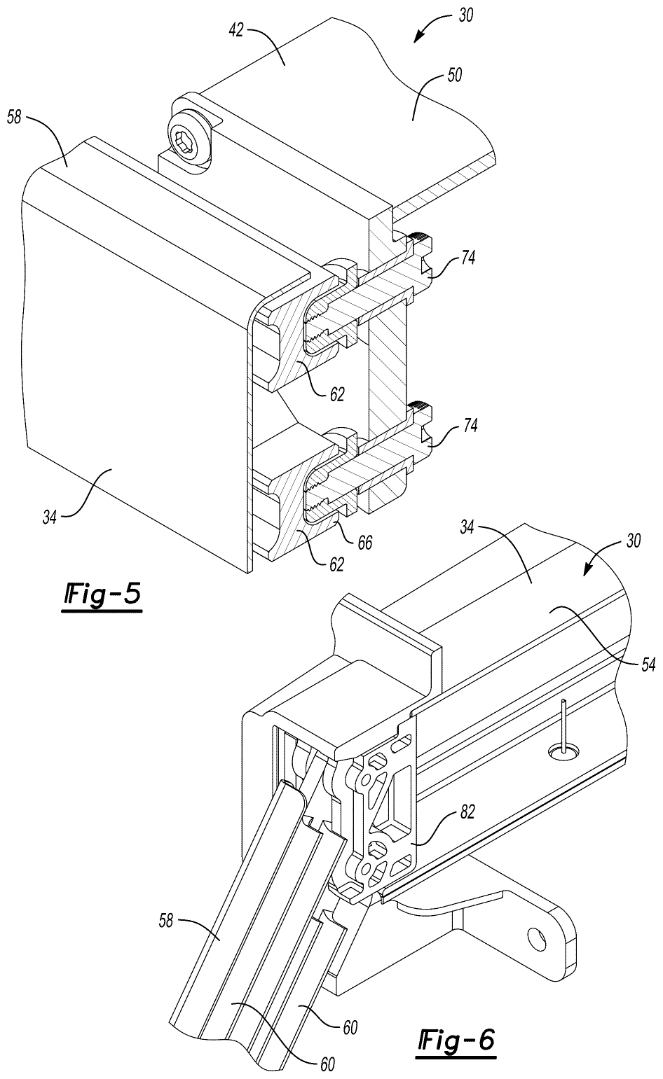

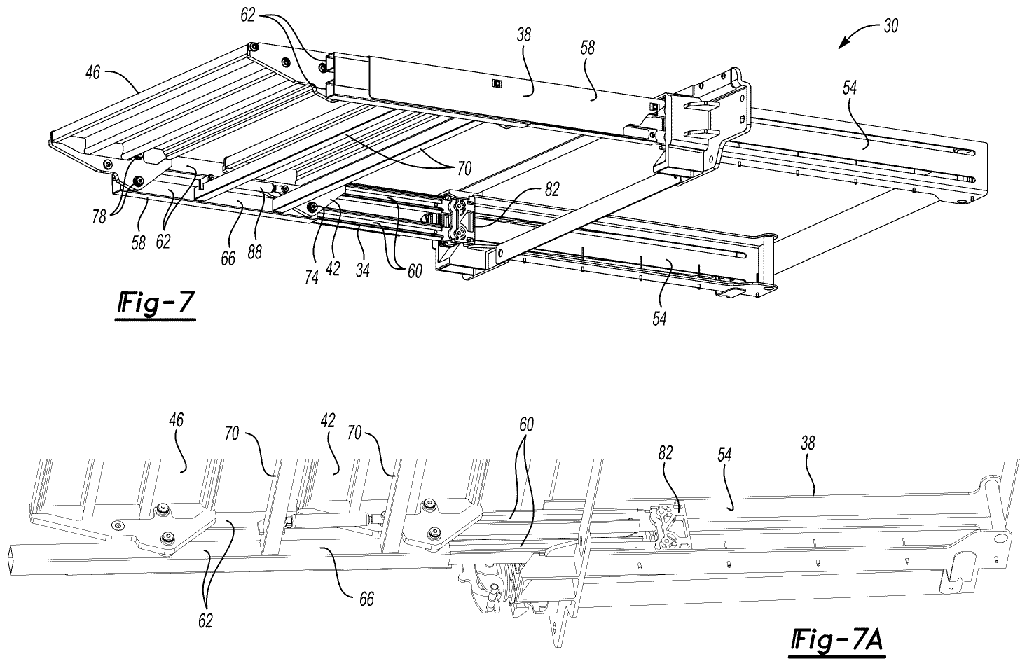

The movable shields 58, inner bars 60, and outer bars 62 are blocked from pivoting relative to the respective slider brackets 82 until the slider brackets 82 have reached aft ends of the respective fixed rails 54. Contact between the inner bars 60 and the fixed rails 54, or between the outer bars 62 and the fixed rails 54 can block such downward pivoting. As shown in FIGS. 6 and 7, when stair assembly 30 is in the extended position, the movable shields 58, inner bars 60, and the outer bars 62 are free to pivot downward relative to the slider brackets 82 without the movable shields 58, inner bars 60, or outer bars 62 contacting the fixed rails 54.

In some examples, the stair assembly 30 can be locked in the extended position. A locking assembly, for example, could be used to lock the stair assembly 30. When locked in the extended position, the stair assembly 30 can, in some examples, support a load and effectively extend a length of the cargo bed 14.

In some examples, the stair assembly 30 can be moved and locked in a position that is in between the stowed position of FIG. 2 and the extended position of FIG. 3. This position, shown in FIG. 7A, and be considered a partially extended position. When in the partially extended position, the slider brackets 82, portions of the inner bars 60, and portions of the outer bars 62 are retracted within the tailgate 22. This acts as a lever overlapped with the fixed rails 54 to support the stair assembly 30 cantilevered in the partially extended position. The stair assembly 30, when partially extended, is blocked from rotating downward to the staircase position. In this example, contact between the inner bars 60 and the fixed rails 54, or contact between the outer bars 66 and the fixed rails 54, blocks such rotation. The stair assembly 30 can be locked in the partially extended position in some examples. The lock is then released to permit the stair assembly 30 to move to the extend position of FIG. 3.

The lock can be plunger lock having a release handle beneath one of the steps 50. A plunger of the plunger lock could secure one of the slider brackets 82 relative to one of the fixed rails 54. A plunger lock could also be used to restrict movement (e.g., play) of the steps 50 when the stair assembly 30 is in the staircase position of FIG. 1. A release handle for this plunger lock could also be positioned beneath one of the steps 50.

In this example, the stair assembly 30 includes at least one lift assist 88. The movement of the stair assembly 30 from the extended position of FIG. 2 to the staircase position of FIG. 4 is damped by the at least one lift assist 88. That is, the at least one lift assist 88 slows the speed at which the stair assembly 30 transitions from the extended position of FIG. 3 to the staircase position of FIG. 1. The lift assist 88 can also assists the user lifting the stair assembly 30 from the staircase position to the extended position.

The stair assembly 30 can, in some examples, be used in connection with a handle that can be stowed within the tailgate 22 alongside the stair assembly 30 in the stowed position. The user can grasp the handle when using the stair assembly 30 to entering and exit the cargo bed 14.

In this example, the stair assembly 30 translates horizontally rearward from the tailgate 22 when transitioning from the stowed position to the extended position. While the example stair assembly 30 is shown as extending rearward from the stowed position, the stair assembly 30 could extend from a vehicle structure in another direction. For example, the stair assembly 30 could extend and retract from a laterally outboard side 92 of the tailgate 22. In such an example, the stair assembly 30 moves laterally outward relative to an orientation of the vehicle 10 when moving from the stowed position within the laterally outboard side 92 of the tailgate 22.

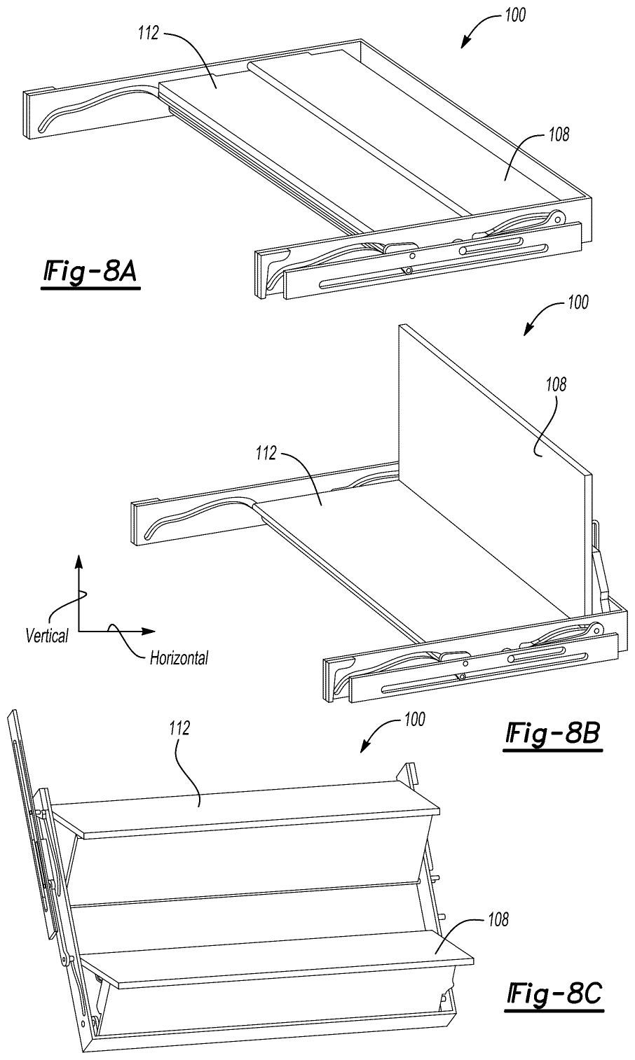

With reference now to FIGS. 8A-8C, a stair assembly 100 according to another exemplary embodiment of the present can extend and retract relative to a structure, such as a tailgate. The steps of the example stair assembly 100 are not configured to pivot together. As shown in FIG. 8B, a step 108 of the stair assembly 100 can be pivoted upward while the other step 112 of the stair assembly 100 is not pivoted upward.

The step 108 that is pivoted upward can provide a load stop when the stair assembly 100 is in a partially extended or a fully extended position relative to the tailgate. Cargo, such as a sheet of material, can be stowed within the cargo bed area. The step 108 providing the load stop can help to block movement of material from the cargo bed area. The stair assembly 100 can, in some examples, include a locking system that can lock the stair assembly 100 in a partially extended or fully extended position. This can permit positioning, and locking, of the step 108 providing the load stop at a plurality of horizontal positions, which can help to adjust the load stop to a particular load.

With reference now to FIGS. 9A and 9B, a stair assembly 200 according to yet another exemplary embodiment includes two independently pivotable steps 204 and 208. A user can utilize the stair assembly 200 to access a cargo bed of a vehicle when the stair assembly 200 is in the staircase position of FIG. 9B.

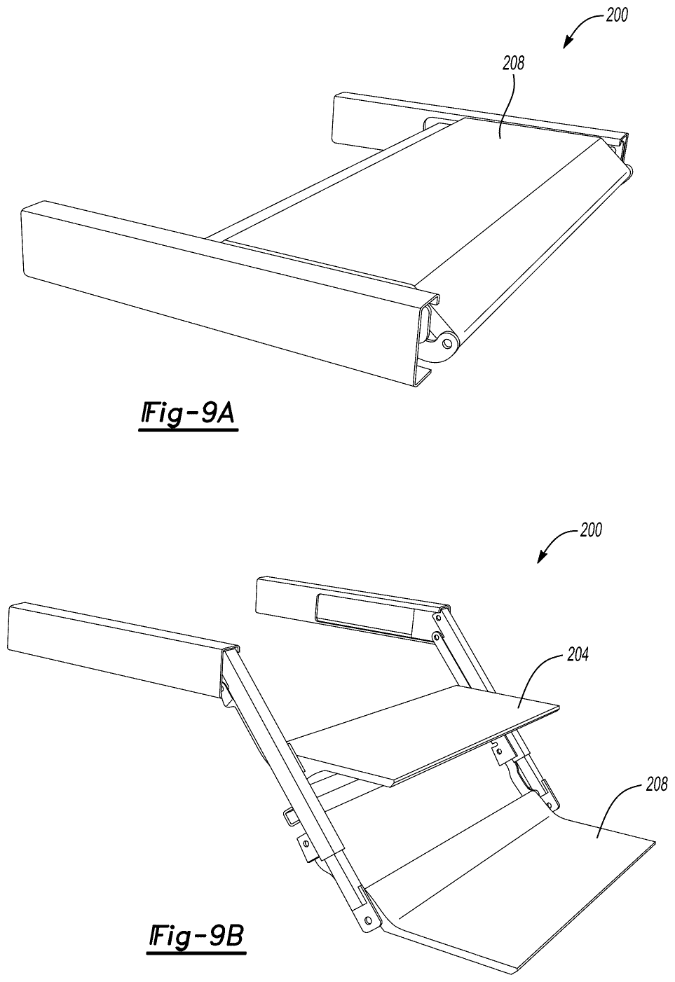

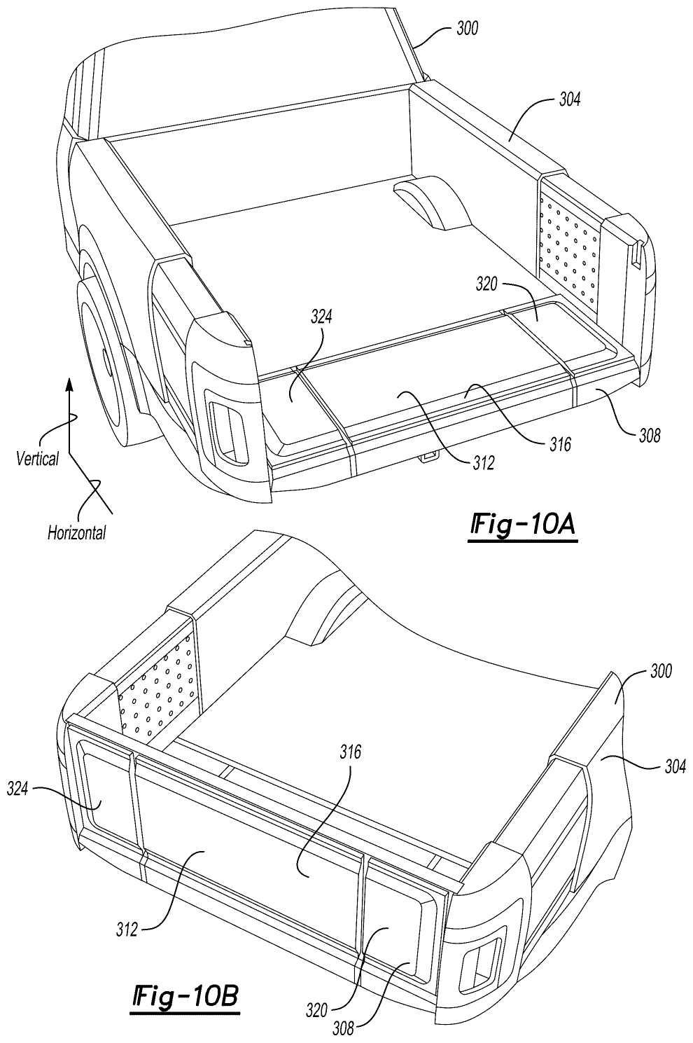

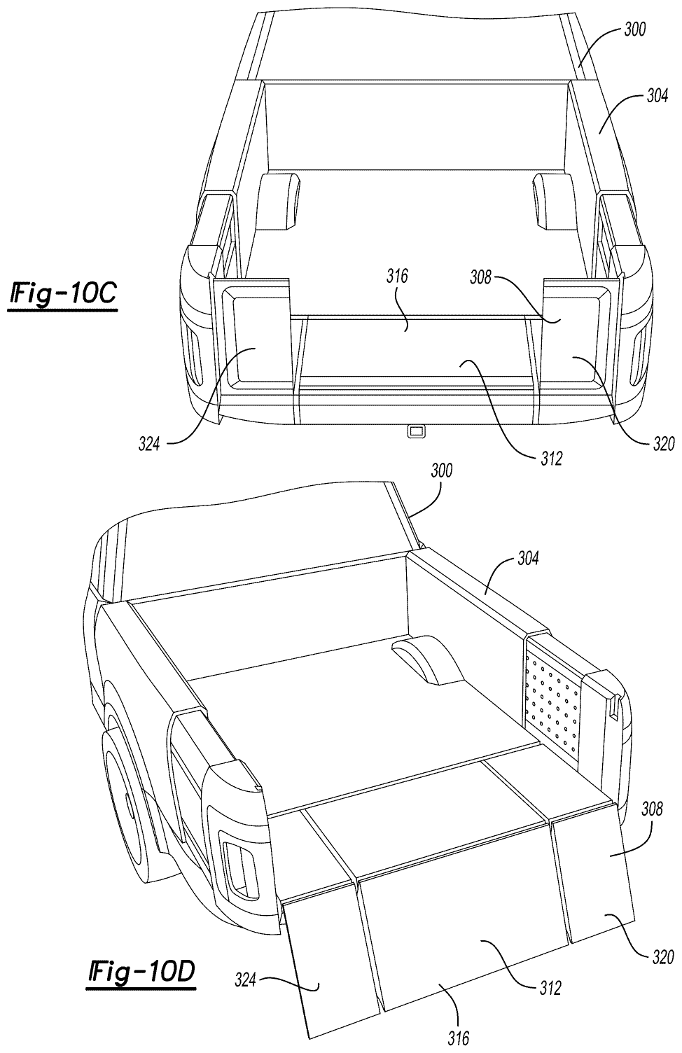

With reference now to FIGS. 10A-10D, an example vehicle 300 can include a cargo bed 304 that is extendible. The cargo bed 304 is movable between a standard position and an extended position. FIGS. 10A-10D show the cargo bed 304 in the extended position. The example step assemblies of FIGS. 1-9B can be used with a cargo bed that is extendable or a cargo bed that is not extendable.

A tailgate 308 of the vehicle 300 includes a flip-up work surface system 312. The flip-up work surface system 312 includes, in this example, a central section 316, a passenger side section 320, and a driver side section 324, which are each pivotably coupled to the tailgate 308.

With the tailgate 308 open as shown in FIGS. 10A-10B, the sections can be pivoted from a horizontal position shown in FIG. 10A to a vertical position shown in FIG. 10B. The central section 316, the passenger side section 320, and the driver side section 324, can each be locked in the vertical position to provide a load stop.

The central section 316, the passenger side section 320, and the driver side section 324, are independently pivotable. For example, as shown in FIG. 10C, the central section 316 can remain in the horizontal position while the passenger side section 320 and the driver side section 324 are pivoted to the vertical position. This positioning may be useful to provide access to areas of a cargo bed 304 of the vehicle 300.

In this example, the central section 316, the passenger side section 320, and the driver side section 324, can each pivot past the vertical position to a ramp or loading position shown in FIG. 10D. Placing one or more of the central section 316, the passenger side section 320, and the driver side section 324, in the loading position can provide a ramp to help a user load cargo into the cargo bed 304.

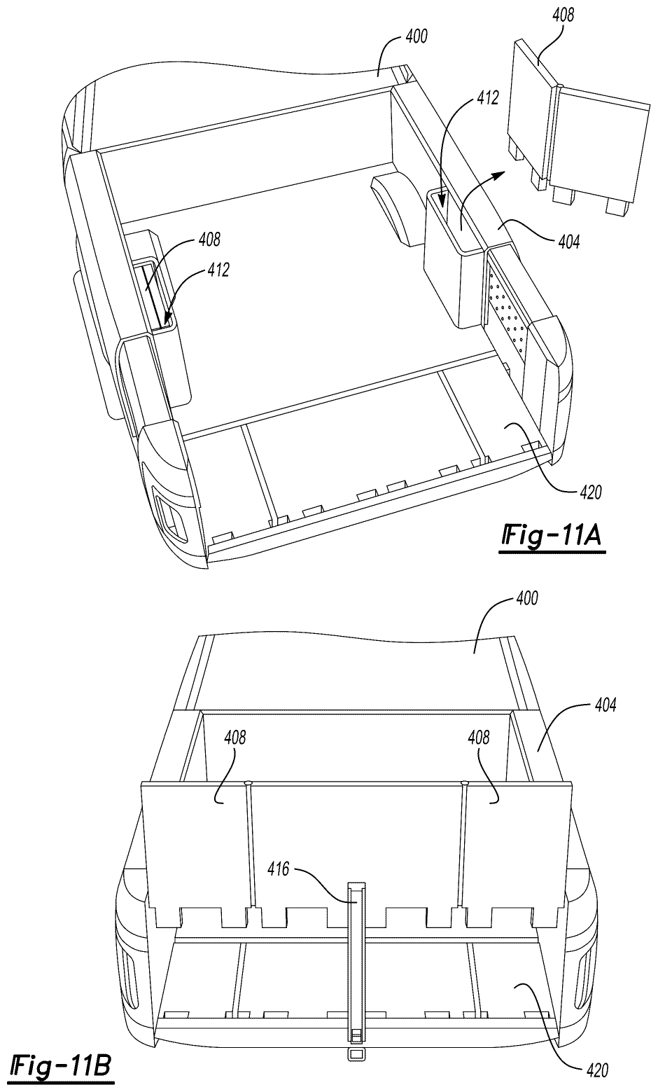

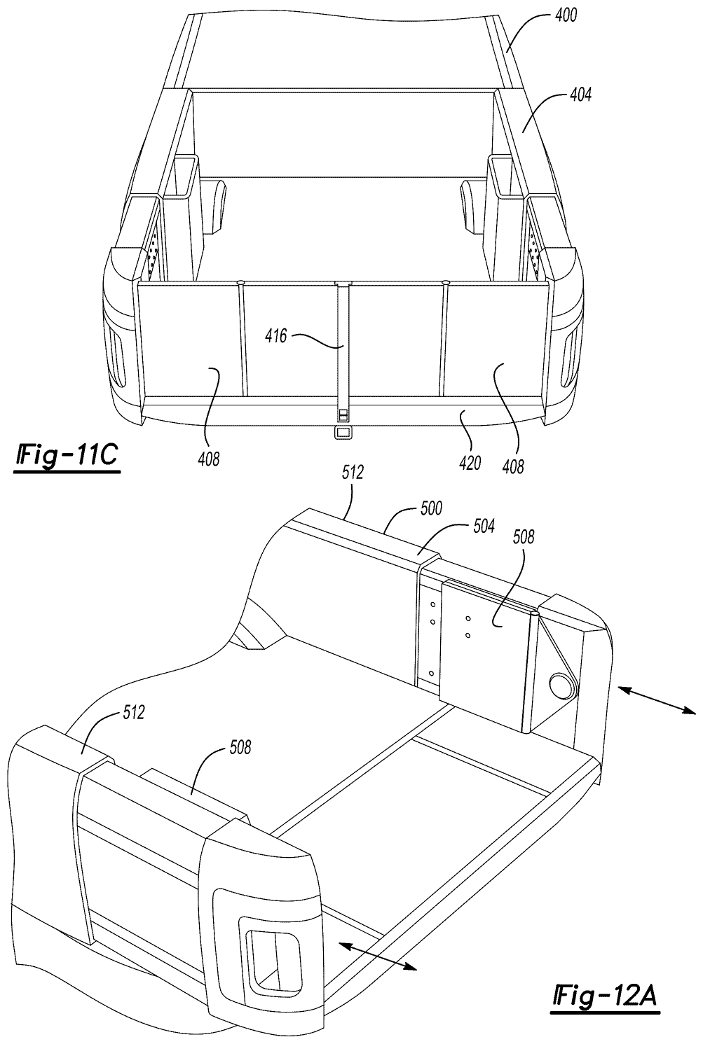

With reference now to FIGS. 11A-11C, a vehicle 400 having a cargo bed 404 includes one or more stowable barriers 408. In this example, when not in use, the stowable barriers 408 are stored within a pocket 412 in the cargo bed 404 as shown in FIG. 11A. The stowable barriers 408 are foldable in this example.

The stowable barriers 408 can be removed from the pockets 412, unfolded, and then secured to an aft end of the cargo bed 404 to provide a load stop as shown in FIGS. 11B and 11C. A support post 416 can extend from a position within a tailgate 420 of the vehicle 400 to help stabilize the stowable barriers 408 when providing the load stop. Instead of, or in addition to the pockets 412 within the cargo bed 404, the stowable barriers 408 could be stowed within a frunk of the vehicle 400, or within a passenger compartment of the vehicle 400.

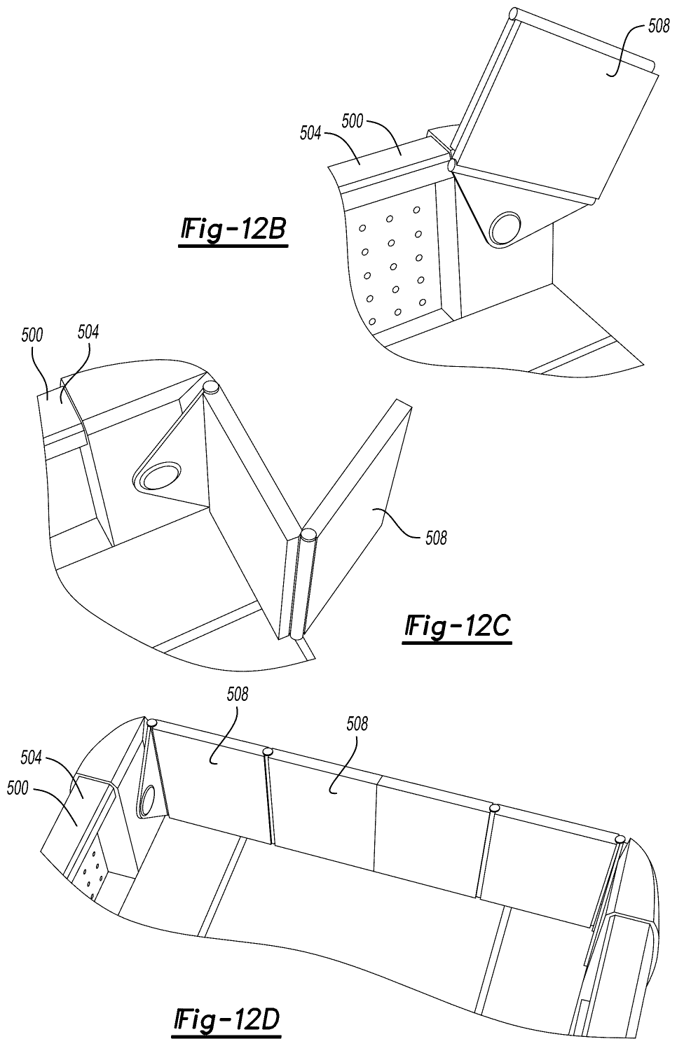

With reference now to FIGS. 12A-12D, a vehicle 500 having a cargo bed 504 includes one or more pivotable barriers 508. In this example, a pivotable barrier 508 is coupled to each cargo bed sidewall 512 of the vehicle 500.

The cargo bed 504 is extendable in this example. When the cargo bed 504 is not in an extended position, the pivotable barriers 508 are held within the cargo bed sidewalls 512 of the vehicle 500. When the cargo bed 504 is transitioned to the extended position as shown, the pivotable barriers are withdrawn from within the sidewalls.

Once withdrawn, the pivotable barriers 508 can be pivoted and unfolded as shown in FIGS. 12B and 12C to provide a load stop at the aft end of the cargo bed 504 as shown in FIG. 12D.

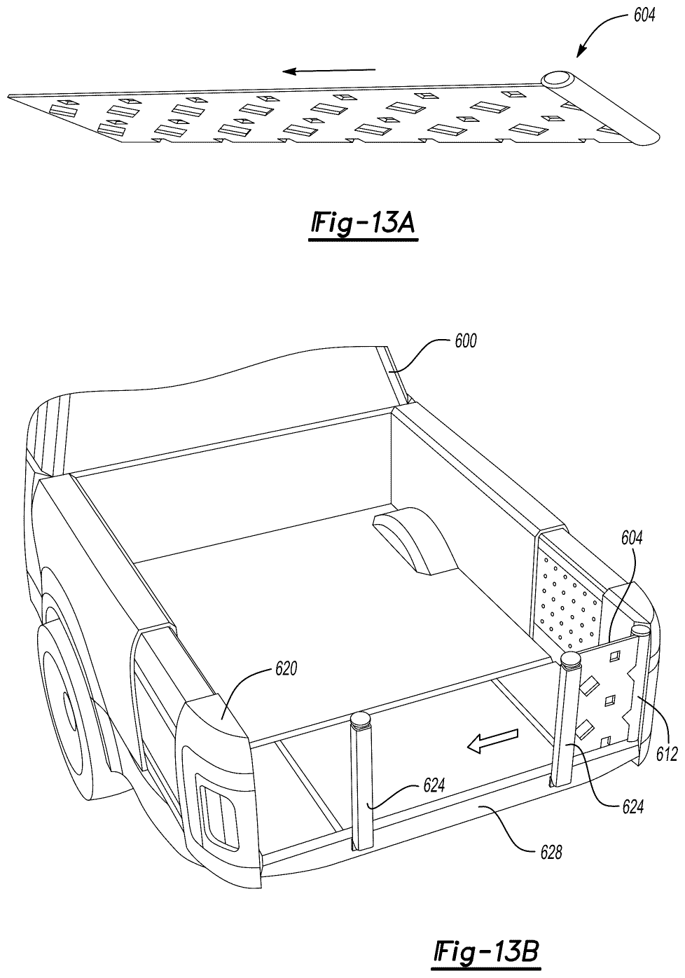

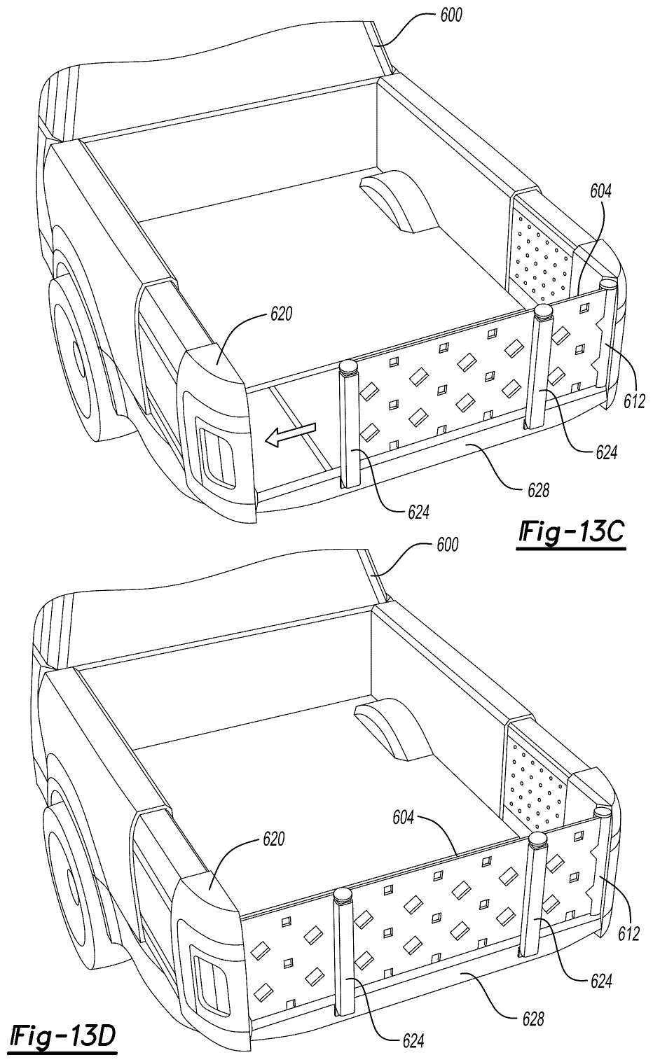

With reference now to FIGS. 13A-13D, an example vehicle 600 includes one or more roller load stops 604. The roller load stops 604 includes a barrier 608 that can be rolled about a shaft within a housing 612. The barrier 608 can be unrolled from the shaft, and the housing 612 secured to a tailgate 616 as shown in FIGS. 13B-13D. The barrier 608 can extend from the housing 612 to a sidewall 620 of the vehicle 600. The barrier 608 spans between the housing 612 and the sidewall 620 to provide a load stop. Support posts 624 can be coupled to the vehicle 600 to help support the barrier 608 when spanning between the housing 612 and the sidewall 620. The support posts 624 can be withdrawn from a stowed position within a tailgate 628 of the vehicle 600.

When the load stop is no longer required, the barrier 608 can be rerolled about the shaft and contained within the housing 612 for storing within the vehicle 600. In some examples, the barrier 608 can be screen printed with graphics, which may aesthetically enhance the appearance of the load stop when in the unrolled position. The roller load stops 604 can be removable to enable a quick swap of one roller load stop 604 with another. This can facilitate changing roller load stops 604 to change graphics, for example, to allow a user to customize a vehicle with a desired appearance.

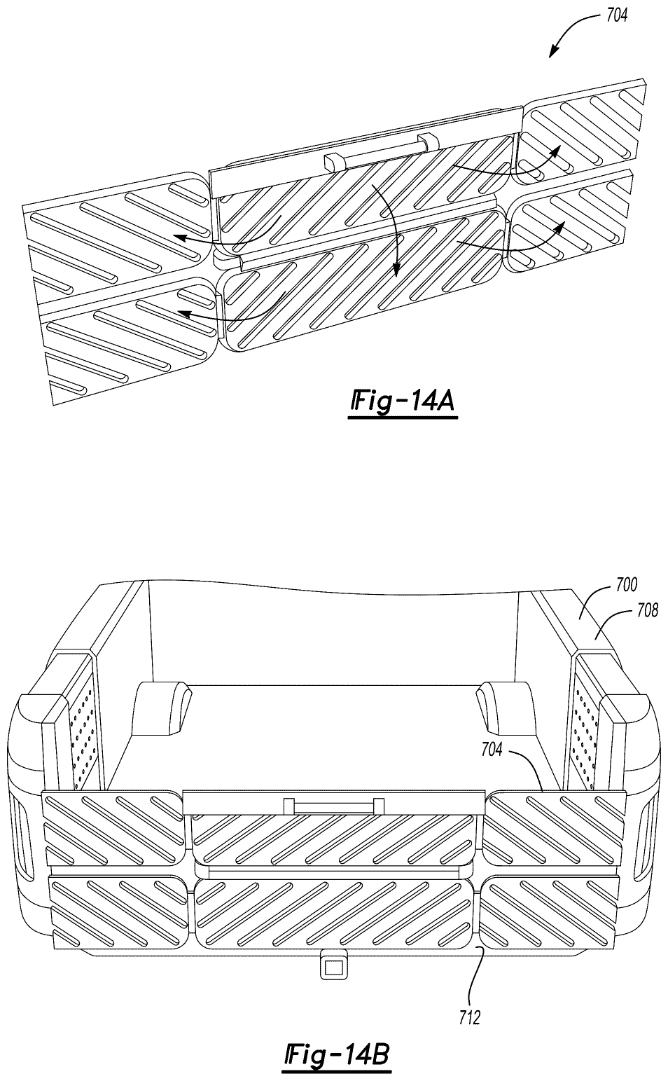

With reference now to FIGS. 14A and 14B, another example vehicle 700 includes a slide-out load stop 704 that can be unfolded to provide a load stop enclosing an aft end of a cargo bed 708. When folded, the slide-out load stop 704 can be stowed within a tailgate 712 of the vehicle 700, or elsewhere within the vehicle 700.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A stair assembly for a vehicle, comprising:
a first support arm assembly and a second support arm assembly spaced apart from one another;
a first step extending between the first support arm assembly and the second support arm assembly;
a second step extending between the first support arm assembly and the second support arm assembly; and
the first support arm assembly including a fixed rail and a telescoping portion movable relative to the fixed rail,
wherein the first step and the second step are coupled to the telescoping portion such that extension of the telescoping portion moves the first step and the second step from a retracted position toward an extended position,
wherein the first step and the second step are pivotable relative to the first support arm assembly and the second support arm assembly to a staircase position in which step surfaces of the first step and the second step face upward.

2. The stair assembly of claim 1, wherein the telescoping portion includes an inner bar received within an outer bar.

3. The stair assembly of claim 1, further comprising a shield covering at least part of the telescoping portion when the telescoping portion is extended.

4. The stair assembly of claim 1, wherein the first support arm assembly and the second support arm assembly each include a four-bar linkage that constrains pivoting of the first step and the second step to maintain the step surfaces substantially horizontal during transition to the staircase position.

5. The stair assembly of claim 1, further comprising a locking assembly configured to retain the first step and the second step in the retracted position.

6. The stair assembly of claim 1, wherein the first step and the second step pivot together to the staircase position.

7. The stair assembly of claim 1, wherein the first support arm assembly and the second support arm assembly each include two outer bars and two inner bars forming a parallelogram linkage.

8. The stair assembly of claim 7, wherein the outer bars of the first support arm assembly define a first four-bar linkage and the outer bars of the second support arm assembly define a second four-bar linkage, the first and second four-bar linkages being parallel to one another.

9. The stair assembly of claim 1, wherein the fixed rail couples the first support arm assembly to a tailgate of the vehicle.

10. A tailgate system for a vehicle, comprising:
a tailgate movable between a closed position and an open position;
a stair assembly movable between a stowed position within the tailgate and a staircase position outside the tailgate, the stair assembly including:
a first support arm assembly having a fixed rail and an a telescoping portion that is telescopically received within the fixed rail;
a second support arm assembly spaced from the first support arm assembly;
a first step and a second step each spanning between the first support arm assembly and the second support arm assembly; and
a pivot connection between each of the first step and the second step and the first support arm assembly and the second support arm assembly, wherein movement of the extendable rail from the stowed position to an extended position moves the first step and the second step outward of the tailgate, and wherein pivoting of the first step and the second step relative to the first support arm assembly and the second support arm assembly positions the first step and the second step in the staircase position.

11. The tailgate system of claim 10, wherein the staircase position is a vertically downward and rearward position relative to the tailgate.

12. The tailgate system of claim 10, wherein the stair assembly is slidable along the fixed rail during movement between the stowed position and the extended position.

13. The tailgate system of claim 10, wherein a locking assembly mounted to the tailgate engages the stair assembly in the stowed position.

14. The tailgate system of claim 10, wherein the first step and the second step pivot together relative to the first support arm assembly and the second support arm assembly such that respective step surfaces remain substantially horizontal in the staircase position.

15. A method of deploying a stair assembly of a vehicle, comprising:
opening a tailgate of the vehicle;
moving the stair assembly from a stowed position within the tailgate to an extended position outside the tailgate by telescopically extending a support arm assembly of the stair assembly; and
pivoting a first step and a second step of the stair assembly downward relative to the support arm assembly to a staircase position in which step surfaces of the first step and the second step face upward to assist a user in entering or exiting a cargo bed of the vehicle.

16. The method of claim 15, further comprising locking the stair assembly in the stowed position within the tailgate.

17. The method of claim 15, wherein pivoting the first step and the second step includes rotating the first step and the second step together such that the step surfaces remain substantially horizontal throughout rotation.

18. The method of claim 15, further comprising sliding the stair assembly along a rail in the tailgate during movement from the stowed position to the extended position.

19. The method of claim 15, further comprising telescoping an inner bar within an outer bar of the support arm assembly during movement to the extended position.
